(19) United States
(12) Patent Application Publication
(10) Pub. No.: US 2026/0296236 A1
(43) Pub. Date: Oct. 1, 2026

(54) POWER MANAGEMENT APPARATUS AND POWER MANAGEMENT METHOD

(71) Applicant: HONDA MOTOR CO., LTD., Tokyo (JP)

(72) Inventors: Masanori Sasaki, Tokyo (JP); Masaki Ueno, Tokyo (JP)

(21) Appl. No.: 19/542,690

(22) Filed: Feb. 18, 2026

(30) Foreign Application Priority Data
Mar. 28, 2025 (JP) 2025-056043

(51) Int. Cl. B60L 53/30; B60L 53/51; B60L 53/52; B60L 53/62; G06Q 50/06

(52) U.S. Cl. CPC B60L 53/305; B60L 53/51; B60L 53/52; B60L 53/62; G06Q 50/06; B60L 2250/16

(57) ABSTRACT

A power management apparatus includes vehicle management part that manages amount of renewable energy stored in in-vehicle power storage device of an electrified vehicle having the in-vehicle power storage device, and an acquisition part configured to acquire a renewable energy content rate included in grid energy. The vehicle management part includes a calculation part configured to calculate renewable energy content information related to the amount of renewable energy in the grid energy stored in the in-vehicle power storage device on the basis of the renewable energy content rate, a summing part configured to calculate a sum value obtained by summing an amount of first renewable energy based on the renewable energy content information and an amount of second renewable energy generated by the power generation device, and a providing part configured to provide first display information that causes a display part to display a first display regarding the sum value.

### CROSS-REFERENCE TO RELATED APPLICATION

Priority is claimed on Japanese Patent Application No. 2025-056043, filed Mar. 28, 2025, the content of which is incorporated herein by reference.

### BACKGROUND OF THE INVENTION

### Field of the Invention

The present invention relates to a power management apparatus and a power management method.

### Description of Related Art

In recent years, research and development into renewable energy that contributes to energy efficiency has been underway to ensure that more people have access to affordable, reliable, sustainable and advanced energy. Meanwhile, in the field of renewable energy technology, a technology relating to a management system for managing the charging and driving of an electrified vehicle that uses renewable energy and grid energy has been disclosed (see, for example, Japanese Patent No. 6224205). This management system clearly manages the origin of energy and promotes the use of renewable energy by providing incentives when renewable energy is selected for driving.

### SUMMARY OF THE INVENTION

The management system disclosed in Japanese Patent No. 6224205 visualizes and displays physical quantities related to driving using renewable energy as an energy source. This display enables users to experience the use of renewable energy, thereby encouraging users to use renewable energy. On the other hand, some grid energy is generated using renewable energy generation methods such as solar power and wind power.

For this reason, in reality, even users who primarily use grid energy may also use renewable energy, but in the technology disclosed in Japanese Patent No. 6224205, this is not included in the physical quantities related to renewable energy. Therefore, users are unable to fully experience the use of renewable energy, and it is difficult to increase awareness of the need to use renewable energy.

Aspects of the present invention provide a power management apparatus and a power management method that can increase users'awareness of using renewable energy. Aspects of the present invention contribute to energy efficiency.
(1) According to an aspect of the present invention, there is provided a power management apparatus including: a vehicle management part configured to manage an amount of renewable energy stored in an in-vehicle power storage device of an electrified vehicle, the electrified vehicle having the in-vehicle power storage device that is charged with renewable energy generated by a power generation device and grid energy from a grid energy source which are transmitted from a charging station to which the renewable energy and the grid energy are supplied, the charging station including a charging station management part configured to manage an amount of renewable energy at the charging station; and an acquisition part configured to acquire a renewable energy content rate included in the grid energy, in which the vehicle management part includes: a calculation part configured to calculate renewable energy content information related to the amount of renewable energy in the grid energy stored in the in-vehicle power storage device on the basis of the renewable energy content rate; a summing part configured to calculate a sum value obtained by summing an amount of first renewable energy based on the renewable energy content information and an amount of second renewable energy generated by the power generation device; and a providing part configured to provide first display information that causes a display part to display a first display regarding the sum value.
(2) In the power management apparatus according to the aspect of (1), the providing part may provide second display information that causes the display part to display a second display regarding the amount of second renewable energy.
(3) In the power management apparatus according to the aspect of (1), the providing part may provide switch display information that enables the first display and the second display to be switched and displayed on the display part.
(4) In the power management apparatus according to the aspect of (1), the acquisition part may acquire the renewable energy content rate according to a supply destination of the grid energy stored in the in-vehicle power storage device.
(5) The power management apparatus according to the aspect of (1) may further include a settlement information management part configured to generate settlement usage information to be used for settling purchase and sale of electric power stored in the in-vehicle power storage device of the electrified vehicle, in which the settlement information management part may generate the settlement usage information on the basis of the amount of second renewable energy.
(6) In the power management apparatus according to the aspect of (1), the display part may be provided in at least one of a user terminal owned by a user of the electrified vehicle or an in-vehicle infotainment of the electrified vehicle.
(7) According to another aspect of the present invention, there is provided a power management method including: managing, by a computer, an amount of renewable energy stored in an in-vehicle power storage device of an electrified vehicle, the electrified vehicle having the in-vehicle power storage device that is charged with renewable energy generated by a power generation device and grid energy from a grid energy source which are transmitted from a charging station to which the renewable energy and the grid energy are supplied, the charging station including a charging station management part configured to manage an amount of renewable energy at the charging station; acquiring, by the computer, a renewable energy content rate included in the grid energy; calculating, by the computer, renewable energy content information related to the amount of renewable energy in the grid energy stored in the in-vehicle power storage device on the basis of the renewable energy content rate; calculating, by the computer, a sum value obtained by summing an amount of first renewable energy based on the renewable energy content information and an amount of second renewable energy generated by the power generation device; and providing, by the computer, first display information that causes a display part to display a first display regarding the sum value.

According to the above aspects (1) to (7), it is possible to increase users'awareness of using renewable energy.

### BRIEF DESCRIPTION OF THE DRAWINGS

FIG. 1 is a diagram showing an example of a configuration of a power management system according to an embodiment.

FIG. 2 is a diagram showing an example of the details of a first display image displayed on a touch panel.

FIG. 3 is a diagram showing an example of the details of a green power content rate.

FIG. 4 is a flowchart showing an example of processing performed by a power management apparatus.

FIG. 5 is a diagram showing an example of a first display image and a second display image that are switched and displayed.

### DETAILED DESCRIPTION OF THE INVENTION

A power management apparatus and a power management method according to embodiments of the present invention will be described below with reference to the accompanying drawings. In the drawings used in the following description, the scale of each member has been changed appropriately so that each member can be recognized. In all the drawings for describing the embodiments, components having the same functions are denoted by the same reference numerals, and repeated descriptions will be omitted.

The expression “on the basis of XX” referred to in the present application means “based on at least XX” and also includes cases where it is based on another element in addition to XX. The expression “on the basis of XX” is not limited to cases where XX is used directly, but also includes cases where XX is used based on calculations or processing. The term “XX” is an arbitrary element (for example, arbitrary information).

In the present embodiment, the proportion of electric power from renewable energy included in the electric power charged to an electrified vehicle is displayed on a display device and provided to a user. When displaying the proportion of renewable energy included in the electric power charged to an electrified vehicle, the proportion is prevented from being too low, thereby increasing the user's awareness of using renewable energy. In the following description, “amount of electric power” may refer to “amount of energy.”

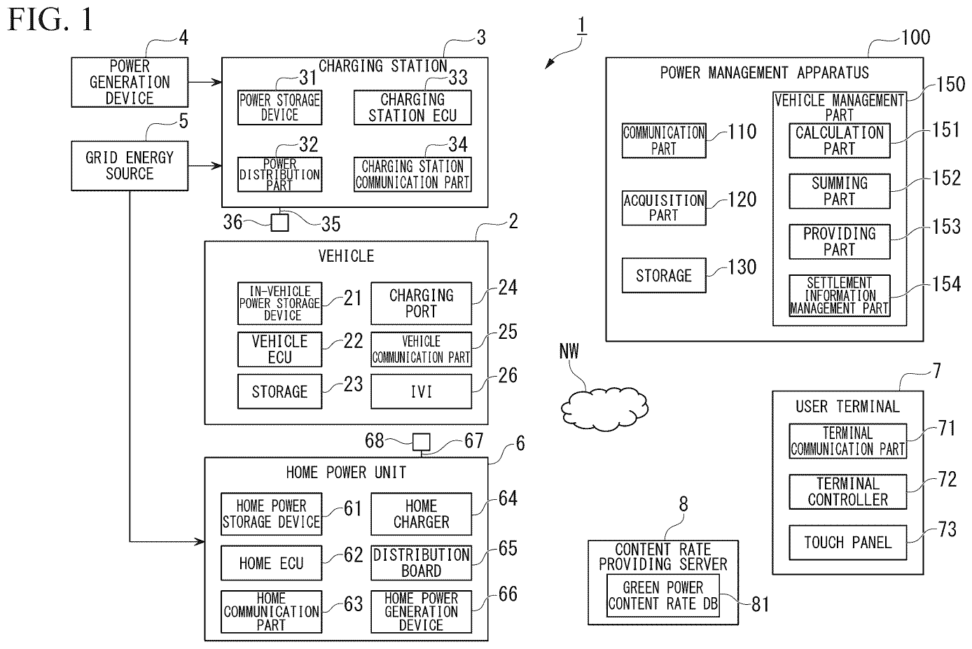

FIG. 1 is a diagram showing an example of a configuration of a power management system 1 according to the present embodiment. The power management system 1 includes, for example, an electrified vehicle 2, a charging station 3, a grid energy source 5, a power generation device 4, a home power unit 6, a user terminal 7, a content rate providing server 8, and a power management apparatus 100. The power management apparatus 100 may be provided outside the electrified vehicle 2, for example, in a management center that manages charging, or may be provided in the charging station 3 or in the electrified vehicle 2.

The electrified vehicle 2, the charging station 3, the grid energy source 5, the power generation device 4, the home power unit 6, the user terminal 7, the content rate providing server 8, and the power management apparatus 100 are communicatively connected to each other via a network NW. The network NW is wireless, for example, but may be wired when the electrified vehicle 2 and the charging station 3 are not moving, such as when charging.

When the stored electric power becomes insufficient, the electrified vehicle 2 travels to, for example, a charging station 3 and receives a supply of electric power from the charging station 3 to be charged. The electric power to be charged is electric power derived from renewable energy (RE) or grid energy (GE). The power management apparatus 100 manages whether the electric power charged to the electrified vehicle 2 is derived from either renewable energy or grid energy.

The electrified vehicle 2 is an electric vehicle (EV) that uses electricity as an energy source and travels with an electric motor (not shown) as a power source. The electrified vehicle 2 includes, for example, an in-vehicle power storage device 21, a vehicle ECU 22, a storage 23, a charging port 24, a vehicle communication part 25, and an in-vehicle infotainment (hereinafter, IVI) 26. The electrified vehicle 2 is, for example, an electric vehicle, but the electrified vehicle 2 may also be a hybrid vehicle, a fuel cell vehicle, an electric motorcycle, or the like.

The in-vehicle power storage device 21 is a storage battery, a capacitor, or the like that is mounted on the electrified vehicle 2. The in-vehicle power storage device 21 stores the electric power transmitted from the charging station 3 or the home power unit 6 when the electrified vehicle 2 and the charging station 3 or the home power unit 6 are electrically connected to each other. The electric power stored in the in-vehicle power storage device 21 may be electric power derived from renewable energy (hereinafter referred to as renewable energy-derived electric power), electric power derived from grid energy (hereinafter referred to as grid energy-derived electric power), or both.

The electric power stored in the in-vehicle power storage device 21 is supplied to each part (for example, the electric motor) of the electrical system of the electrified vehicle 2. The in-vehicle power storage device 21 may be provided with identifiable identification information. The in-vehicle power storage device 21 may include a plurality of cells, and each cell may be provided with identifiable identification information.

The vehicle ECU 22 is an electronic control unit. The vehicle ECU 22 controls the storage of electric power in the in-vehicle power storage device 21 and controls the supply of the stored electric power to each part of the electrical system of the electrified vehicle 2. The vehicle ECU 22, the in-vehicle power storage device 21, the electric motor, the vehicle communication part 25, and the like are connected to one another via communication lines such as a controller area network (CAN).

The vehicle ECU 22 calculates a distance traveled by the vehicle (hereinafter referred to as a travel distance) on the basis of the detection results of various sensors such as wheel speed sensors. The vehicle ECU 22 manages and monitors the remaining capacity SOC (State Of Charge) of the electric power (energy) stored in the in-vehicle power storage device 21. The vehicle ECU 22 stores the acquired travel distance and remaining capacity SOC of energy in the storage 23.

The vehicle ECU 22 transmits the acquired travel distance and remaining capacity SOC of energy to the power management apparatus 100 using the vehicle communication part 25. The vehicle ECU 22 may calculate the power consumption of the electrified vehicle 2 on the basis of the calculated travel distance. In this case, the vehicle ECU 22 may store the calculated power consumption in the storage 23 or transmit the calculated power consumption to the power management apparatus 100 using the vehicle communication part 25.

The vehicle ECU 22 may store the electric power generated by the regenerative energy of the electric motor in the in-vehicle power storage device 21. When the in-vehicle power storage device 21 includes a plurality of cells, the vehicle ECU 22 may store, in the storage 23, information about which cell stores the renewable energy-derived electric power in association with the identification information of the cell. Regenerative energy may be treated separately from renewable energy and grid energy.

The vehicle ECU 22 may calculate the power of a load other than the electric motor, such as an air conditioner, and store the calculated power in the storage 23 or transmit the calculated power to the power management apparatus 100 using the vehicle communication part 25. When the load is an air conditioner provided in the electrified vehicle 2, the vehicle ECU 22 may calculate the amount of power consumed by the air conditioner on the basis of the time the air conditioner has been used, the set temperature, etc., and store the calculated amount of power in the storage 23.

The storage 23 is, for example, a semiconductor memory element such as a flash memory, a hard disk, an optical disc, or the like. The storage 23 stores information such as the amount of energy acquired by the vehicle ECU 22, the calculated travel distance, and the remaining capacity SOC of the in-vehicle power storage device 21. The travel distance and remaining capacity SOC stored in the storage 23 are transmitted by the vehicle communication part 25 to the charging station 3 and the power management apparatus 100 as necessary. Information such as the travel distance and remaining capacity SOC may be transmitted to the charging station 3 or the power management apparatus 100 without being stored in the storage 23.

A charging plug 36 provided at the charging station 3 and a home charging plug 68 provided at the home power unit 6 can be connected to the charging port 24. When the charging plug 36 or the home charging plug 68 is connected to the charging port 24, the electrified vehicle 2 is electrically connected to the charging station 3 or the home power unit 6 via a cable 35 or a home cable 67. By electrically connecting the electrified vehicle 2 to the charging station 3 or the home power unit 6, it becomes possible to charge the electrified vehicle 2 with electric power from the charging station 3 or the home power unit 6.

The vehicle communication part 25 includes a communication interface such as a network interface card (NIC card). The vehicle communication part 25 transmits and receives information to and from the charging station 3 and the power management apparatus 100. The vehicle communication part 25 transmits, for example, the travel distance and the remaining capacity SOC of the in-vehicle power storage device 21 acquired by the vehicle ECU 22 or stored in the storage 23 to the power management apparatus 100 via the network NW.

The IVI 26 is, for example, a system for providing information and entertainment to the occupants of the electrified vehicle 2. The IVI 26 includes, for example, a display. The IVI 26 provides information to the user, which is the occupant, by displaying an image containing the information on a display. The information displayed on the IVI 26 includes, for example, information regarding the proportion of renewable energy-derived electric power included in the electric power charged to the electrified vehicle 2.

The charging station 3 obtains renewable energy of electric power from the power generation device 4, which is generated and supplied by the power generation device 4, and also obtains grid energy from the grid energy source 5, which is supplied by the grid energy source 5. Grid energy is mainly the energy of electric power generated by power generation devices, such as thermal power generation devices, which emit a large amount of CO₂ during power generation.

Grid energy also includes renewable energy such as electric power generated by energy generation devices with low CO₂ emissions during power generation (hereinafter referred to as green power generation devices), such as solar panels, wind power generation devices, and geothermal power generation devices. In the following description, the renewable energy included in the grid energy will be referred to as “first renewable energy.” The charging station 3 manages the amount of renewable energy obtained from the power generation device 4 (hereinafter referred to as second renewable energy). In the following description, unless otherwise specified, “renewable energy” refers to “second renewable energy.”

The charging station 3 supplies renewable energy-derived electric power or grid energy-derived electric power to the electrified vehicle 2. The power generation device 4 may be provided at the charging station 3, or may be provided outside the charging station 3, for example, at a power plant, and renewable energy may be supplied, for example, from the power generation device 4 at the power plant via a cable. The grid energy is supplied from the grid energy source 5 such as an electric power company via a cable. The charging station 3 may be equipped with an operation unit, a display part, etc. A plurality of charging stations 3 may be installed, for example, at each business base of a business operator that operates the charging stations 3.

The charging station 3 includes, for example, a power storage device 31, a power distribution part 32, a charging station ECU 33, and a charging station communication part 34. The power storage device 31 stores electric power. The power storage device 31 is, for example, a storage battery or a capacitor. The power storage device 31 stores renewable energy-derived electric power supplied by the power generation device 4 and grid energy-derived electric power supplied by the grid energy source 5. The power storage device 31 supplies the stored electric power to the power distribution part 32 in accordance with the control of the charging station ECU 33. The charging station 3 may not be provided with the power storage device 31, and in this case, the charging station 3 may directly supply the grid energy supplied by the grid energy source 5 to the electrified vehicle 2.

The cable 35 is connected to the power distribution part 32, and the charging plug 36 is connected to the cable 35. A plurality of cables 35 and a plurality of charging plugs 36 may be provided. The power distribution part 32 supplies the renewable energy-derived electric power or the grid energy-derived electric power stored in the power storage device 31 to the electrified vehicle 2 via the cable 35 and the charging plug 36 in accordance with the control of the charging station ECU 33. Electric power may be supplied directly to the electrified vehicle 2 from the grid energy source 5 or the power storage device 31 without passing through the power distribution part 32. The charging plug 36 is, for example, a charging plug based on the “J1772” standard or the “CHAdeMO” standard. The charging plug 36 may be compatible with other charging standards.

The charging station ECU 33 manages the amount of renewable energy stored in the power storage device 31 and the total amount of grid energy and renewable energy charged to the electrified vehicle 2 (hereinafter referred to as the total amount of charging energy). The charging station ECU 33 provides the power management apparatus 100 with the amount of renewable energy and the total amount of charging energy that the charging station ECU 33 manages. The charging station ECU 33 is an example of a charging station management part.

The charging station communication part 34 includes, for example, a communication interface such as an NIC card. The charging station communication part 34 transmits and receives information to and from the power management apparatus 100 and the like. The charging station communication part 34 transmits, for example, the amount of renewable energy provided by the charging station ECU 33 and the total amount of charging energy to the power management apparatus 100.

The power generation device 4 is a green power generation device that generates electric power as renewable energy. The grid energy source 5 is, for example, a source of electric power supplied by an electric power company. The grid energy source 5 is mainly a power generation device such as a thermal power generation device that emits a large amount of CO₂ during power generation. The grid energy source 5 also includes a green power generation device. In the following description, among the grid energy-derived electric power, electric power generated by a green power generation device will be referred to as green power.

The home power unit 6 is provided, for example, in the home of a user who owns the electrified vehicle 2. The home power unit 6 includes, for example, a home power storage device 61, a home ECU 62, a home communication part 63, a home charger 64, a distribution board 65, and a home power generation device 66. The home cable 67 and the home charging plug 68 similar to the charging plug 36 are connected to the home charger 64.

The home power storage device 61 stores electric power. The home power storage device 61 is, for example, a storage battery or a capacitor. The home power storage device 61 stores renewable energy-derived electric power generated by the home power generation device 66 or supplied by the power generation device 4, or grid energy-derived electric power supplied by the grid energy source 5. The power storage device 31 supplies the stored electric power to the home charger 64 in accordance with the control of the charging station ECU 33.

The home ECU 62 manages the amount of renewable energy stored in the home power storage device 61 and the total amount of charging energy charged to the electrified vehicle 2. The home ECU 62 provides the power management apparatus 100 with the amount of renewable energy and the total amount of charging energy that the home ECU 62 manages. The home ECU 62 may manage the amount of energy of the electric power charged to or consumed by home appliances in the home, and the amount of energy of the electric power sold to the electric power company.

The home communication part 63 includes, for example, a communication interface such as an NIC card. The home communication part 63 transmits and receives information to and from the charging station 3, the power management apparatus 100, and the like. The home communication part 63 transmits, for example, the amount of renewable energy provided by the home ECU 62 and the total amount of charging energy to the power management apparatus 100.

The home cable 67 is connected to the home charger 64, and the home charging plug 68 is connected to the home cable 67. The home charger 64 supplies the grid energy and renewable energy stored in the home power storage device 61 to the electrified vehicle 2 via the home cable 67 and the home charging plug in accordance with the control of the home ECU 62.

The distribution board 65 distributes the electric power generated by the home power generation device 66 or supplied by the power generation device 4 or the grid energy source 5 to the home power storage device 61 and the home charger 64. The distribution board 65 may also serve as the home ECU 62. The distribution board 65 may distribute (sell) the electric power generated by the home power generation device 66 or supplied by the power generation device 4 or the grid energy source 5 to home appliances or electric power companies.

The home power generation device 66 is a green power generation device, similarly to the power generation device 4. The home power generation device 66 is mainly a solar panel. The home power generation device 66 may be a wind power generation device, a geothermal power generation device, or the like. The electric power generated by the home power generation device 66 is used to charge the home power storage device 61 and is supplied to the electrified vehicle 2 via the home charger 64. The electric power generated by the home power generation device 66 may be sold to an electric power company or the like.

The user terminal 7 is, for example, a terminal device owned by a user who owns the electrified vehicle 2. The user terminal 7 is, for example, a smartphone or a tablet. The user terminal 7 may be, for example, a personal computer provided in the home power unit 6 or the like. The user terminal 7 includes, for example, a terminal communication part 71, a terminal controller 72, and a touch panel 73.

The terminal communication part 71 includes, for example, a communication interface such as an NIC card. The terminal communication part 71 transmits and receives information to and from the power management apparatus 100 and the like. The terminal communication part 71 receives information such as a green power content rate for display transmitted by the power management apparatus 100, for example. The green power content rate for display indicates, for example, the proportion of green power that is assumed to be included in the total power charged in the in-vehicle power storage device 21 of the electrified vehicle 2 used by the user.

The terminal communication part 71 may acquire a proportion of second renewable energy-derived electric power (hereinafter referred to as a second renewable energy content rate) included in the electric power charged to the in-vehicle power storage device 21 of the electrified vehicle 2 owned by the user (hereinafter referred to as the total charged electric power). The terminal communication part 71 outputs the received information such as the green power content rate for display to the terminal controller 72 or the like.

The terminal controller 72 acquires information transmitted by the power management apparatus 100 and output by the terminal communication part 71. The terminal controller 72 acquires, for example, the green power content rate for display output by the terminal communication part 71. The terminal controller 72 may acquire the second renewable energy content rate output by the terminal communication part 71. Various types of information is displayed on the touch panel 73. The terminal controller 72, for example, causes the touch panel 73 to display the acquired green power content rate for display as a clean energy usage rate. The terminal controller 72 may cause the touch panel 73 to display the second renewable energy content rate.

The touch panel 73 functions as an input device that receives input operations from the user, and has a function as a display device that displays information provided by the terminal controller 72. Instead of the touch panel 73, the user terminal 7 may be provided with an input device such as a numeric keypad and an output device such as a display. For example, under the control of the terminal controller 72, the touch panel 73 displays the green power content rate for display as a clean energy usage rate. The touch panel 73 may display the second renewable energy content rate, for example, under the control of the terminal controller 72.

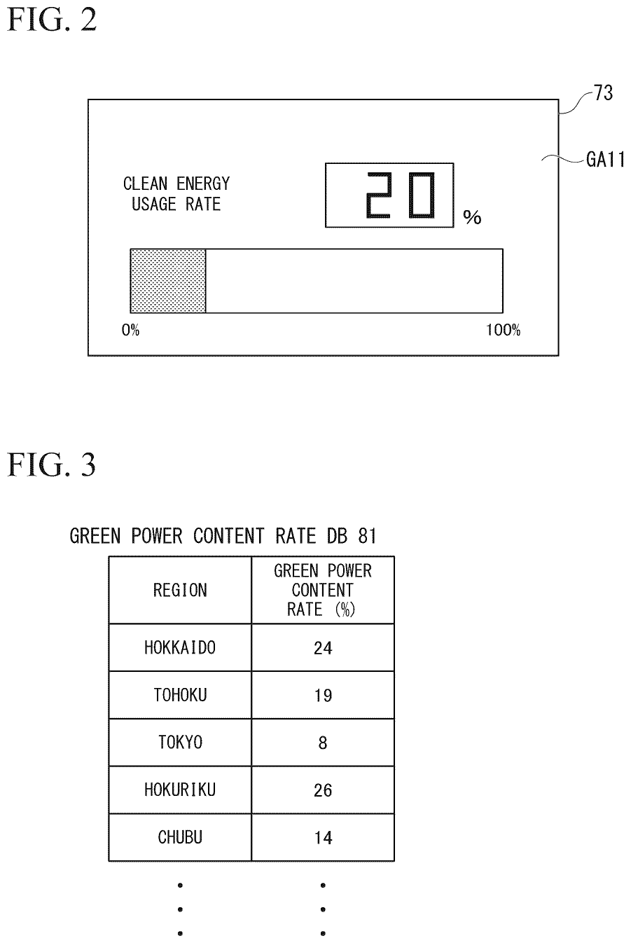

FIG. 2 is a diagram showing an example of the details of a first display image GA11 displayed on the touch panel 73. The first display image GA11 displays the characters “clean energy usage rate” and, next to the characters, numerical information indicating the green power content rate for display. Below the characters, an indicator is displayed. The indicator includes an image of a gauge that varies depending on the green power content rate for display. For example, the user understands the amount of green power included in the electric power charged to the electrified vehicle 2 by looking at the number indicating the green power content rate for display, and understands an image of the proportion of green power that is accounted for in the total by looking at the indicator. The first display image GA11 is an example of a first display.

The content rate providing server 8 is installed, for example, at an electric power information provider, and extracts information on the proportion of first renewable energy-derived electric power included in grid energy-derived electric power for each region (hereinafter referred to as contained green power ratio information). The content rate providing server 8 stores, for example, a green power content rate database (hereinafter referred to as DB) 81. In the following description, the first renewable energy-derived electric power will also be referred to as green power. The green power content rate DB 81 is updated as appropriate on the basis of various types of information. The proportion of the first renewable energy-derived electric power included in the grid energy-derived electric power is an example of a renewable energy content rate.

FIG. 3 is a diagram showing an example of the details of the green power content rate DB 81. The green power content rate DB 81 indicates, for example, the proportion of green power included in grid energy-derived electric power for each region (hereinafter referred to as an actual green power content rate). For example, in Hokkaido, the actual green power content rate is 24%. This information shows that the grid energy-derived electric power provided in Hokkaido contains 24% green power and 76% non-green power.

The content rate providing server 8 acquires the actual green power content rate from various types of information related to the actual green power content rate provided from an external device or the like. The actual green power content rate includes information provided by, for example, an electricity map. The content rate providing server 8 updates the green power content rate DB 81 as needed on the basis of the acquired various types of information related to the actual green power content rate.

The content rate providing server 8 extracts and provides the contained green power ratio information in response to a request from an external device, for example, a request from the power management apparatus 100. The power management apparatus 100 requests the contained green power ratio information by designating, for example, a region. The content rate providing server 8 extracts and provides contained green power ratio information for the designated region as contained green power ratio information based on the supply destination of the grid energy stored in the in-vehicle power storage device. The content rate providing server 8 provides the actual green power content rate for regions in Japan, but may also provide the actual green power content rate for regions in various countries around the world.

The power management apparatus 100 is a server provided in, for example, a power management center. The power management apparatus 100 calculates green power for display to provide the user with the proportion of renewable energy-derived electric power included in the total charged electric power charged to the electrified vehicle 2 that runs on electrical energy, and transmits the calculated green power for display to the user terminal 7 for provision. By viewing the green power for display that is displayed on the user terminal 7, the user becomes more aware of the need to use renewable energy.

The power management apparatus 100 includes, for example, a communication part 110, an acquisition part 120, a storage 130, and a vehicle management part 150. The vehicle management part 150 includes, for example, a calculation part 151, a summing part 152, a providing part 153, and a settlement information management part 154. For example, the acquisition part 120 and the vehicle management part 150 are realized by a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), or a graphics processing unit (GPU), or may be realized by software and hardware in cooperation.

A program may be stored in the storage 130 such as an HDD or a flash memory (a storage device including a non-transitory storage medium) in advance or may be stored in an attachable/detachable storage medium such as a DVD or a CD-ROM (a non-transitory storage medium) such that the program is installed when the storage medium is mounted in a drive device.

The communication part 110 includes, for example, a communication interface such as an NIC card. The communication part 110 transmits and receives information to and from the electrified vehicle 2, the charging station 3, the home power unit 6, the user terminal 7, the content rate providing server 8, and the like. The communication part 110 receives the amount of renewable energy and the total amount of charging energy transmitted by the charging station communication part 34 and the home communication part 63 and outputs them to the vehicle management part 150.

The acquisition part 120 acquires the renewable energy content rate included in the grid energy. The acquisition part 120 acquires, for example, the contained green power ratio information provided by the content rate providing server 8. To acquire the contained green power ratio information, the acquisition part 120 transmits request information requesting the provision of the contained green power ratio information to the content rate providing server 8.

The acquisition part 120 includes information on the installation region indicating the region where the charging station 3 and the home power unit 6 are installed in the request information. The content rate providing server 8 references the installation region information included in the request information to the green power content rate DB 81 to extract the contained green power ratio information, and transmits the contained green power ratio information to the power management apparatus 100 for provision. The acquisition part 120 acquires the contained green power ratio information transmitted by the content rate providing server 8.

The storage 130 is a semiconductor memory element such as a flash memory, a hard disk, an optical disc, or the like. The storage 130 may be an external drive device. The storage 130 stores various types of information related to the electric power charged to the electrified vehicle 2 in addition to the above programs.

The calculation part 151 calculates renewable energy content information related to the amount of renewable energy in the grid energy stored in the in-vehicle power storage device 21 on the basis of the renewable energy content rate. The calculation part 151 calculates the amount of green power included in the grid energy-derived electric power, for example, on the basis of the total amount of charging energy output by the communication part 110 and the contained green power ratio information acquired by the acquisition part 120. The amount of green power included in the grid energy-derived electric power is an example of renewable energy content information.

The summing part 152 calculates the amount of second renewable energy-derived electric power on the basis of the amount of renewable energy transmitted by the charging station communication part 34 and the home communication part 63. The summing part 152 sums the amount of green power calculated by the calculation part 151 and the calculated amount of second renewable energy-derived electric power. The summing part 152 calculates the green power content rate for display by dividing the sum value of the amount of green power and the amount of second renewable energy-derived electric power by the total amount of charging energy.

The providing part 153 generates first display information for visualizing the green power content rate for display calculated by the summing part 152 and displaying it on a display device. The providing part 153 transmits the generated first display information to the user terminal 7 for provision using the communication part 110. The user terminal 7 causes the terminal controller 72 to display the first display image GA11 based on the first display information provided by the providing part 153 on the touch panel 73. The providing part 153 may transmit the first display information to the vehicle ECU 22 for provision via the vehicle communication part 25 of the electrified vehicle 2. In this case, the vehicle ECU 22 may visualize the provided green power content rate for display and display the first display image GA11 shown in FIG. 2 on the display of the IVI 26.

The settlement information management part 154 generates settlement usage information to be used for settling the purchase and sale of electric power between the user of the electrified vehicle 2 and the electric power company that supplies the electric power or the business operator that operates the charging station 3, and provides this information to the parties involved in the electric power purchase and sale. The settlement information management part 154 calculates the actual green power content rate by dividing the amount of second renewable energy-derived electric power by the total amount of charging energy, without taking into account the amount of green power. Grid energy includes first renewable energy, but the content rate of first renewable energy in grid energy is calculated using the contained green power ratio information provided by the content rate providing server 8, and thus a certain degree of error is expected in the green power content rate for display.

On the other hand, the actual green power content rate, which is calculated without taking into account the amount of green power, is calculated using the amount of second renewable energy and the total amount of charging energy measured at the charging station 3 and the home power unit 6. Therefore, the actual green power content rate does not have the error that is expected in the green power content rate for display.

The settlement information management part 154 manages information used for purchase and sale (settlement) of electric power (hereinafter referred to as settlement usage information). The settlement information management part 154 calculates, for example, the actual green power content rate instead of the green power content rate for display, and generates power purchase and sale information for the electric power. The settlement information management part 154 generates settlement usage information including power purchase and sale information. The providing part 153 transmits the settlement usage information generated by the settlement information management part 154 to the parties involved in the electric power purchase and sale.

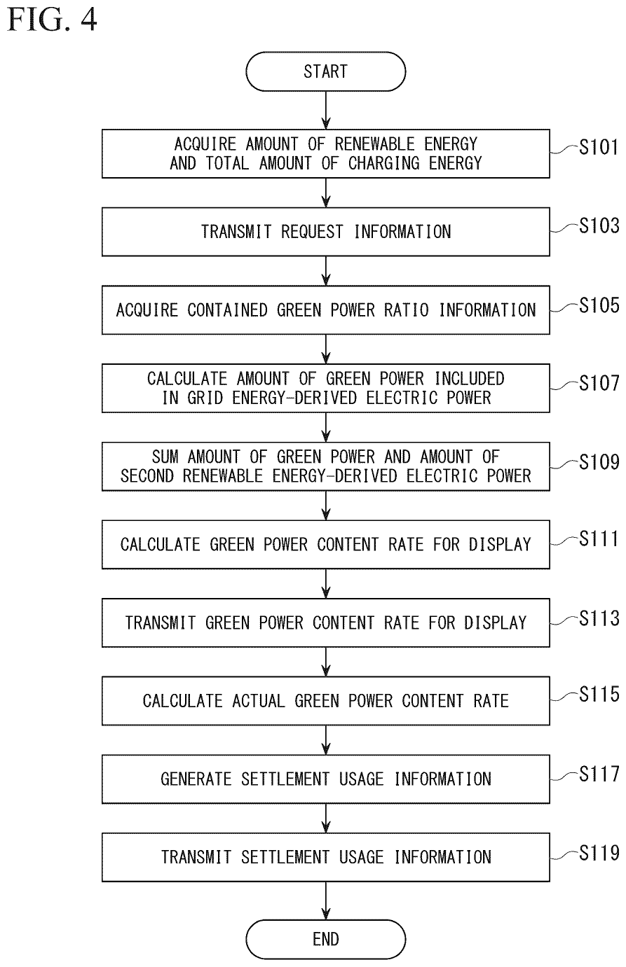

Next, the processing of the power management apparatus 100 will be described. FIG. 4 is a flowchart showing an example of processing performed by the power management apparatus 100. The power management apparatus 100 first receives and acquires the amount of renewable energy (the amount of second renewable energy) and the total amount of charging energy transmitted by the charging station communication part 34 and the home communication part 63 in the communication part 110 (step S101).

Next, the acquisition part 120 transmits request information requesting the provision of contained green power ratio information to the content rate providing server 8 (step S103). The content rate providing server 8 references the region information included in the request information to the green power content rate DB 81, acquires the green power content rate, and transmits the green power content rate to the power management apparatus 100. The power management apparatus 100 acquires the transmitted green power content rate in the acquisition part 120 (step S105).

Next, the calculation part 151 calculates the amount of green power included in the grid energy-derived electric power on the basis of the total amount of charging energy output by the communication part 110 and the contained green power ratio information acquired by the acquisition part 120. When calculating the amount of green power (the amount of first renewable energy) included in the grid energy-derived electric power, the calculation part 151 first calculates the amount of grid energy-derived electric power on the basis of, for example, the total amount of charging energy, and then calculates the amount of green power by multiplying the amount of grid energy-derived electric power by the contained green power ratio information (step S107).

Next, the summing part 152 sums the amount of green power calculated by the calculation part 151 and the amount of second renewable energy-derived electric power acquired by the calculation part 151 (step S109). The summing part 152 calculates the green power content rate for display by dividing the sum value obtained by summing the amount of green power and the amount of second renewable energy-derived electric power by the amount of grid energy-derived electric power (step S111). Next, the providing part 153 transmits the green power content rate for display calculated by the summing part 152 to the user terminal 7 (step S113).

Furthermore, the settlement information management part 154 calculates the actual green power content rate by dividing the amount of second renewable energy-derived electric power calculated by the summing part 152 by the amount of grid energy-derived electric power (step S115). Next, the settlement information management part 154 generates power purchase and sale information on the basis of the calculated actual green power content rate, and generates settlement usage information including the power purchase and sale information (step S117). The power purchase and sale information may be generated on the basis of the amount of second renewable energy-derived electric power calculated by the summing part 152 without calculating the actual green power content rate. The providing part 153 transmits the settlement usage information generated by the settlement information management part 154 to the parties involved in the electric power purchase and sale (step S119). Thus, the power management apparatus 100 ends the processing shown in FIG. 4.

The power management apparatus 100 according to the embodiment calculates the green power content rate for display, which is displayed as the clean energy usage rate on a display device viewed by a user, such as a touch panel 73, including not only the second renewable energy but also the first renewable energy included in the grid energy. Therefore, the clean energy usage rate viewed by the user can be set to a relatively high value, which can increase the user's awareness of using renewable energy.

In the above embodiment, the providing part 153 generates first display information for visualizing the green power content rate for display and displaying it on a display device, and provides the first display information to the user terminal 7 or the electrified vehicle 2, but the providing part 153 may also generate second display information for visualizing the actual green power content rate and displaying it on the display device, and provide the second display information to the user terminal 7 or the electrified vehicle 2. In this case, the providing part 153 may generate switch display information that enables the first display image and the second display image to be switched and displayed, and provide the switch display information to the user terminal 7 or the electrified vehicle 2.

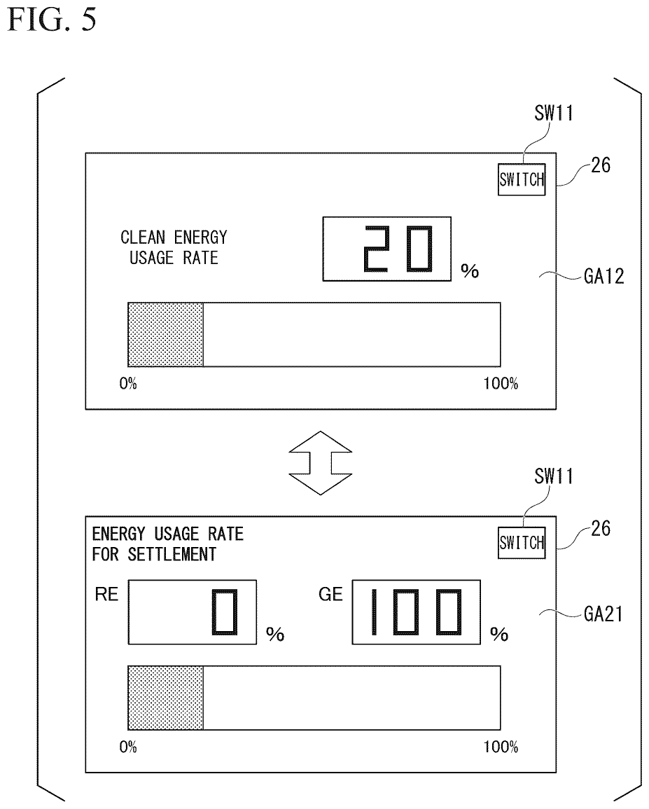

FIG. 5 is a diagram showing an example of a first display image GA11 and a second display image GA12 that are switched and displayed. The upper diagram in FIG. 5 shows an image displaying the details equivalent to that of the first display image GA11 shown in FIG. 2, with a changeover switch image SW11 added. The changeover switch image SW11 is, for example, a graphical user interface (GUI), and when operated by the user, the image displayed on the touch panel 73 is switched to a second display image GA12 shown in the lower diagram of FIG. 5.

The second display image GA12 displays the characters “energy usage rate for settlement” and, below the characters, numerical information indicating the green power content rate for display of the grid energy. Below the characters, the proportion of the total charged electric power that is accounted for by renewable energy-derived electric power (second renewable energy-derived electric power) and the proportion of the total charged electric power that is accounted for by grid energy-derived electric power are displayed. The proportion of renewable energy-derived electric power corresponds to the actual green power content rate and is displayed following the characters “RE,” while the proportion of grid energy-derived electric power is displayed following the characters “GE.”

An indicator is displayed below the proportion of the total charged electric power that is accounted for by each piece of derived electric power. The indicator includes an image of a gauge that varies depending on the actual green power content rate. For example, by looking at the number indicating the actual green power content rate, a user can understand the actual green power content rate, thereby improving user's awareness of the use of green power and promoting the use of green power.

The changeover switch image SW11 is also displayed in the second display image GA12, and when operated by the user, the image displayed on the touch panel 73 is switched to the first display image GA11. In this example, the first display image GA11 and the second display image GA12 can be switched and displayed, but the first display image GA11 and the second display image GA12 may be displayed side by side on the same screen.

In the above embodiment, the green power content rate [%] for display is used to indicate the proportion of grid energy-derived electric power included in the total charged electric power, but it may also be displayed as the amount of charging [kWh]. In the above embodiment, the proportion of grid energy-derived electric power included in the total charged electric power is displayed, but the amount of consumption may be displayed instead of the amount of charging.

The program may also be transmitted from a computer system in which the program is stored in a storage device or the like to another computer system via a transmission medium or by transmission waves in the transmission medium. Here, the “transmission medium” that transmits the program refers to a medium that has the function of transmitting information, such as a network (communication network) such as the Internet or a communication line (communication wire) such as a telephone line. Moreover, the above-mentioned program may be a program for realizing some of the above-mentioned functions. Furthermore, the program may be a so-called difference file (difference program) that can realize the above-described functions in combination with a program already recorded in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A power management apparatus comprising:
a vehicle management part configured to manage an amount of renewable energy stored in an in-vehicle power storage device of an electrified vehicle, the electrified vehicle having the in-vehicle power storage device that is charged with renewable energy generated by a power generation device and grid energy from a grid energy source which are transmitted from a charging station to which the renewable energy and the grid energy are supplied, the charging station including a charging station management part configured to manage an amount of renewable energy at the charging station; and
an acquisition part configured to acquire a renewable energy content rate included in the grid energy,
wherein the vehicle management part includes:
a calculation part configured to calculate renewable energy content information related to the amount of renewable energy in the grid energy stored in the in-vehicle power storage device on the basis of the renewable energy content rate;
a summing part configured to calculate a sum value obtained by summing an amount of first renewable energy based on the renewable energy content information and an amount of second renewable energy generated by the power generation device; and
a providing part configured to provide first display information that causes a display part to display a first display regarding the sum value.

2. The power management apparatus according to claim 1, wherein the providing part provides second display information that causes the display part to display a second display regarding the amount of second renewable energy.

3. The power management apparatus according to claim 2, wherein the providing part provides switch display information that enables the first display and the second display to be switched and displayed on the display part.

4. The power management apparatus according to claim 1, wherein the acquisition part acquires the renewable energy content rate according to a supply destination of the grid energy stored in the in-vehicle power storage device.

5. The power management apparatus according to claim 1, further comprising:
a settlement information management part configured to generate settlement usage information to be used for settling purchase and sale of electric power stored in the in-vehicle power storage device of the electrified vehicle,
wherein the settlement information management part generates the settlement usage information on the basis of the amount of second renewable energy.

6. The power management apparatus according to claim 1, wherein the display part is provided in at least one of a user terminal owned by a user of the electrified vehicle or an in-vehicle infotainment of the electrified vehicle.

7. A power management method comprising:
managing, by a computer, an amount of renewable energy stored in an in-vehicle power storage device of an electrified vehicle, the electrified vehicle having the in-vehicle power storage device that is charged with renewable energy generated by a power generation device and grid energy from a grid energy source which are transmitted from a charging station to which the renewable energy and the grid energy are supplied, the charging station including a charging station management part configured to manage an amount of renewable energy at the charging station;
acquiring, by the computer, a renewable energy content rate included in the grid energy;
calculating, by the computer, renewable energy content information related to the amount of renewable energy in the grid energy stored in the in-vehicle power storage device on the basis of the renewable energy content rate;
calculating, by the computer, a sum value obtained by summing an amount of first renewable energy based on the renewable energy content information and an amount of second renewable energy generated by the power generation device; and
providing, by the computer, first display information that causes a display part to display a first display regarding the sum value.
